(19) United States
(12) Patent Application Publication
(10) Pub. No.: US 2017/0182508 A1
(43) Pub. Date: Jun. 29, 2017

(54) METHOD FOR USING A FLOW OF AIR TO CREATE A PROTECTED FIELD

(71) Applicant: Richard C. Johnson, Meridian, ID (US)

(72) Inventor: Richard C. Johnson, Meridian, ID (US)

(73) Assignee: Richard Johnson, Meridian, ID (US)

(21) Appl. No.: 15/460,947

(22) Filed: Mar. 16, 2017

Related U.S. Application Data
(63) Continuation-in-part of application No. 14/944,553, filed on Nov. 18, 2015, now Pat. No. 9,630,195.
Application No. 14/944,553 is a division of application No. 13/714,372, filed on Dec. 13, 2012, now Pat. No. 9,314,809.
(60) Provisional application No. 61/630,469, filed on Dec. 13, 2011.

(51) Int. Cl. B05B 15/04; B05B 13/00; B05B 7/00

(52) U.S. Cl. CPC B05B 15/0431; B05B 7/0075; B05B 13/005

(57) ABSTRACT

In one embodiment, a method of creating a protected field is disclosed. In one embodiment, the method includes directing a first flow of air around a target space, drawing the first flow of air in through a primary air intake vent to create a first flow field envelope. In one embodiment, a second flow of air is directed within the first flow field envelope.

### RELATED CASES

This application is a continuation in part of Johnson, U.S. patent application Ser. No. 14/944,553 (SAGE001-DIV), filed on Nov. 18, 2015, entitled “RECAPTURE SPRAYER,” which is a divisional of Johnson, U.S. patent application Ser. No. 13/714,372 (SAGE001), filed on Dec. 13, 2012, now U.S. Pat. No. 9,314,809, issued on Apr. 19, 2016, entitled “RECAPTURE SPRAYER,” which claims benefit of U.S. Provisional Patent Application No. 61/630,469, filed on Dec. 13, 2011, entitled “RECAPTURE SPRAYER.” All related cases are herein incorporated by reference in their entirety as if the contents were presented herein directly.

### BACKGROUND

Air pollution is a global hazard and becomes more concerning every year. Particulate pollution, a type of air pollution, refers to particulates found in the air. These particulates may be solid or liquid and are responsible for significant health and environmental issues. Indeed, particulate pollutants are particularly dangerous, and even deadly; some of the particulates in particulate pollution are so small that they can invade a person's lungs, causing serious health consequences. Particulate pollution has been associated with asthma, diabetes, strokes, cardiovascular disease, and chronic obstructive pulmonary disease (COPD). Some experts estimate that the lifespan of a person who breathes particulate pollution year-round may be shortened by one to three years. Furthermore, particulate pollutants are the primary cause of reduced visibility and haze in the United States.

In the Eastern United States, much particulate pollution comes from coal burning power plants. In the Western United States, many particulate pollutants come from diesel engines, agriculture, and fire. According to the American Lung Association (ALA), western states are especially vulnerable to environmental impacts from particulate pollution because persistent drought and wildfire conditions exacerbate existing pollution issues.

In its “State of the Air 2015,” the ALA reports that “[m]ore than 4 in 10 people (nearly 44%) in the United States live in counties that have unhealthful levels of either ozone or particulate pollution.” Over “13 percent of people in the United States live in an area with too many days with unhealthful levels of particulate pollution[,]” while “[c]lose to 41.7 million Americans live in 55 counties that experienced too many days with unhealthy spikes in particulate pollution[.]” These “[s]hort-term spikes in particulate pollution can last from hours to several days and can increase the risk of heart attacks, strokes and emergency room visits for asthma and cardiovascular disease, and most importantly, can increase the risk of early death.” Furthermore, “[n]early 24 million people (7.6%) in the United States live in counties with unhealthful year-round levels of particulate pollution. These people live in the 24 counties where chronic levels are regularly a threat to their health.” Alarmingly, “[e]ven when levels are fairly low, exposure to particles over time can increase risk of hospitalization for asthma, damage to the lungs and, significantly, increase the risk of premature death.”

Chemical sprays are one source of particle pollution. Spray recapture systems have been used in the past to prevent overspray of paint; agricultural chemicals including fertilizers, fungicides, herbicides, and pesticides; and other types of spray discharge intended for one or more target objects. Such sprays may be harmful to environs surrounding the target objects. Thus, in many cases, it may be desirable to mitigate dispersal of such chemicals. In some cases, spray containment shells are used to contain overspray, but very large target objects, such as a fully mature tree or an airplane, may be too large to fit within a practically sized spray containment shell.

Given the serious consequences of air pollution, there is a significant need for a convenient, efficient, and effective way to protect the air by containing particulate pollution.

### SUMMARY

In one embodiment, a method of spraying a target object is disclosed. In one embodiment, the method includes directing a first flow of air around a protected field, drawing at least a portion of the first flow of air in through a primary air intake vent to create a first flow field envelope. In one embodiment, a second flow of air is directed within the protected field.

In one embodiment, an apparatus for spraying a target object includes a primary blower adapted to direct a first flow of air through multiple radially-distributed air vents, a secondary blower, and a spray nozzle. In one embodiment, the radially-distributed air vents are adapted to direct the first flow of air in a first direction. In one embodiment, the secondary blower is adapted to direct a second flow of air in a second direction. In one embodiment, the second direction is approximately opposed to the first direction. In one embodiment, the spray nozzle is adapted to emit a spray into the second flow of air.

The present disclosure will now be described more fully with reference to the accompanying drawings, which are intended to be read in conjunction with both this summary, the detailed description, the claims, and any embodiments specifically discussed or otherwise disclosed. This disclosure may, however, be embodied in many different forms and should not be construed as limited to the embodiments set forth herein; rather, these embodiments are provided by way of illustration only so that this disclosure will be thorough, and convey the full scope of the disclosure to those skilled in the art.

### BRIEF DESCRIPTION OF THE DRAWINGS

FIG. 1 is a perspective view of a recapture sprayer according to one embodiment of the present disclosure;

FIG. 2 is a side view of a recapture sprayer according to one embodiment;

FIG. 3 is a front view of a recapture sprayer according to one embodiment;

FIG. 4 is an isometric top view of a recapture sprayer according to one embodiment;

FIG. 5 is a perspective view of a recapture sprayer in use, according to one embodiment;

FIG. 6 is a perspective view of a first flow of air directed to create a protected field;

FIG. 6A is a perspective view of a second flow of air directed inside a first flow of air to create a protected field;

FIG. 7 is a side view of a first flow of air directed to create a protected field; and

FIG. 8 is a perspective view of a first flow of air directed in a planar orientation to create a protected field.

Common reference numerals are used throughout the FIG.s and the detailed description to indicate like elements. One skilled in the art will readily recognize that the above FIG.s are examples and that other embodiments can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be implemented in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

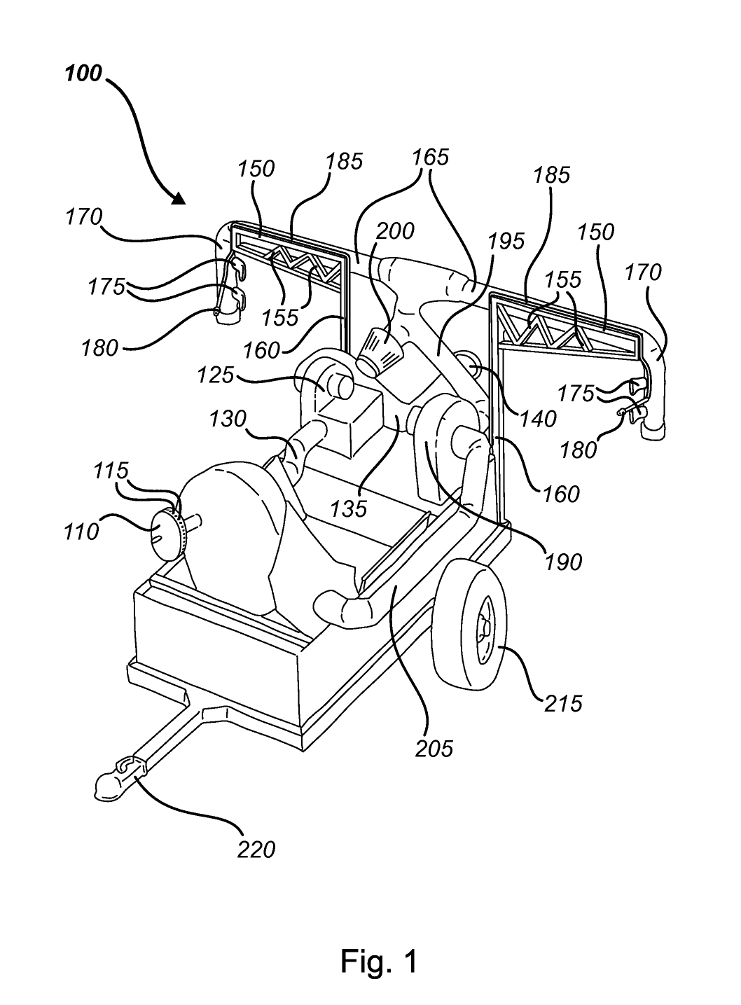

With reference to FIG. 1, an embodiment of the present disclosure includes vehicle 100. In one embodiment, vehicle 100 includes a non-self-propelled vehicle adapted for towing behind a tractor or similar self-propelled vehicle. In various embodiments, vehicle 100 includes a self-propelled vehicle. Vehicle 100 may be adapted for use in orchards, fields, on-road, or other various environments. Another embodiment of the present disclosure is stationary.

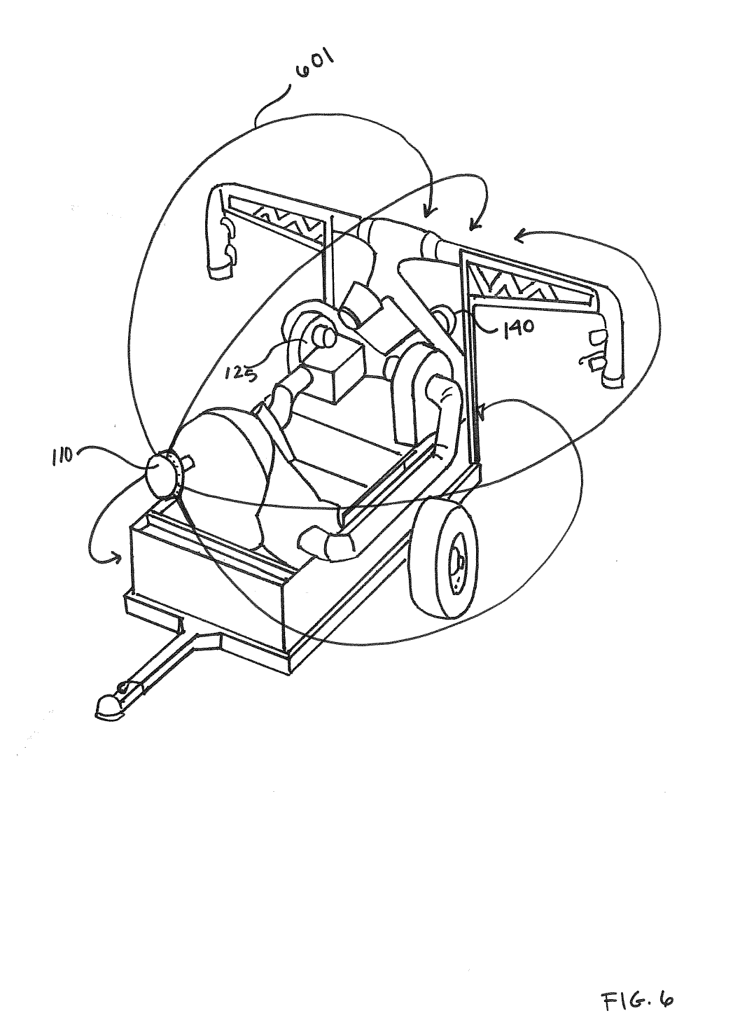

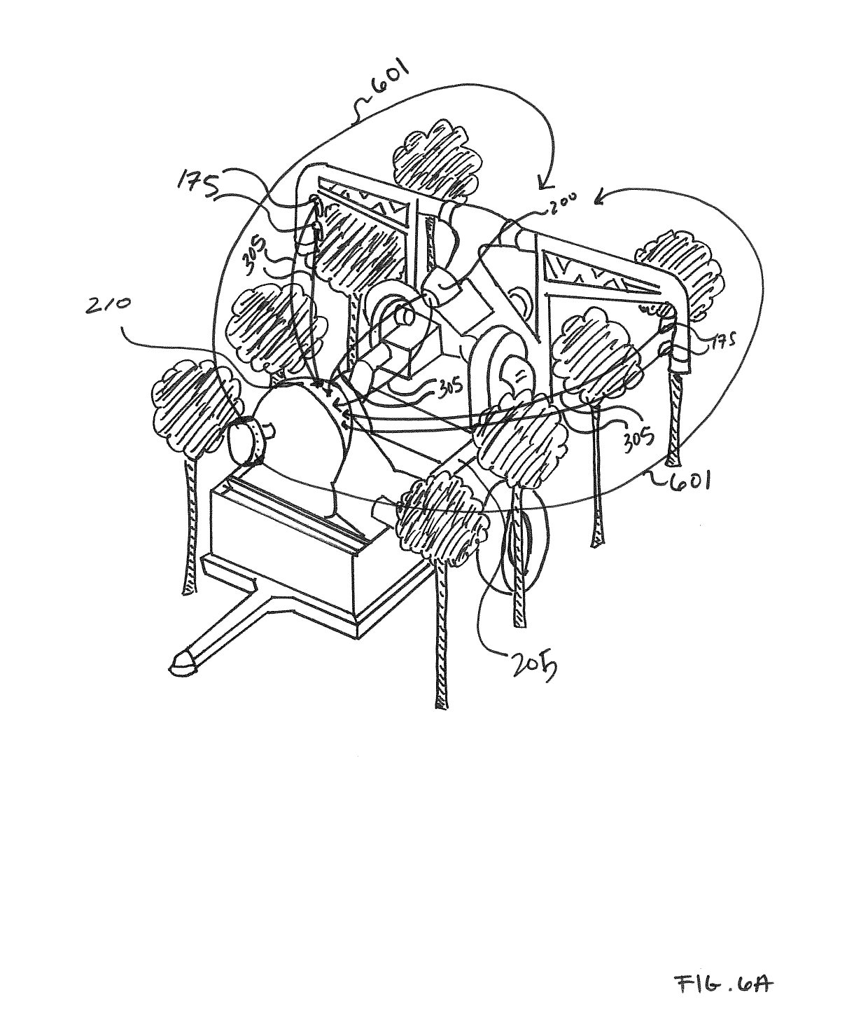

Various embodiments of the present disclosure include nose member 110. In one embodiment, nose member 110 includes multiple radially-distributed air vents 115. In one embodiment, air vents 115 include pass-through holes in nose member 110 in communication with an inner volume of nose member 110, which includes a plenum. In one embodiment, air vents 115 are targeted at multiple radially-distributed directions roughly perpendicular to a direction of travel of vehicle 100. In various embodiments, air vents 115 are directed at points behind nose member 110, such that an emitted flow of air may be directed at various angles. In one embodiment, approximately forty air vents 115 are distributed roughly evenly around nose member 110. Various embodiments may include other numbers of air vents 115 while still falling under the scope of the present disclosure. In one embodiment, plenum of nose member 110 is in fluid communication with an output port of primary blower 125 via primary blower outlet duct 130. In one embodiment, primary blower inlet duct 135 is attached at an inlet port of primary blower 125 and includes primary air intake vent 140 located at the rear of vehicle 100. In one embodiment, primary air intake vent 140 includes vent filter 145. In various embodiments, a particulate recapture system (not depicted) may be located within primary air intake vent 140 or primary blower inlet duct 135. Particulate recapture is further discussed in FIG. 6A.

In one embodiment, the apparatus depicted in FIG. 1 includes side support beams 150. In one embodiment, side support beams 150 include trestle members 155. In one embodiment, near the rear of vehicle 100, stanchions 160 support side support beams 150 and anchor side support beams 150 to vehicle 100. In one embodiment, side support beams 150 support secondary air pipes 165, which extend laterally beyond each side of vehicle 100. In various embodiments, side support beams 150 are integrated with secondary air pipes 165. For example, in one embodiment, side support beams 150 include a steel tube through which a flow of air may be carried. In one embodiment, secondary air pipes 165 include downturn pipes 170 at their lateral extremities, upon which secondary side vents 175 are attached. In one embodiment, spray nozzles 180 are also attached on downturn pipes 170 and are connected to spray hose 185, which provides fluid communication to a storage tank (not depicted). In one embodiment, the storage tank includes an atomizer or other apparatus to convert liquid within the tank to an aerosol prior to transmitting the aerosol in a fluid stream through spray hose 185. In one embodiment, the storage tank may be installed on vehicle 100 or on a tow vehicle.

In one embodiment, secondary air pipes 165 are in fluid communication with an output port of secondary blower assembly 190 via secondary blower outlet duct 195. In one embodiment, secondary central vent 200 is also in communication with secondary blower outlet duct 195. In one embodiment, secondary central vent 200 includes a nozzle having internal vanes adapted to create cyclonic air movement on a flow of air passing through the secondary central vent. In one embodiment, secondary blower inlet duct 205 is attached at an inlet port of secondary blower 190 and includes fluid communication to secondary air intake vent 210 located behind nose member 110 near the front of vehicle 100. In various embodiments, a filtration system (not depicted) may be located within secondary air intake vent 210 or secondary blower inlet duct 205.

In one embodiment, additional spray nozzles 180 are located at or near secondary air intake vent 210 and/or secondary central vent 200. In various embodiments, functions served by primary blower 125 and/or secondary blower assembly 190 may be fulfilled instead by one or more air compressors and/or air generators.

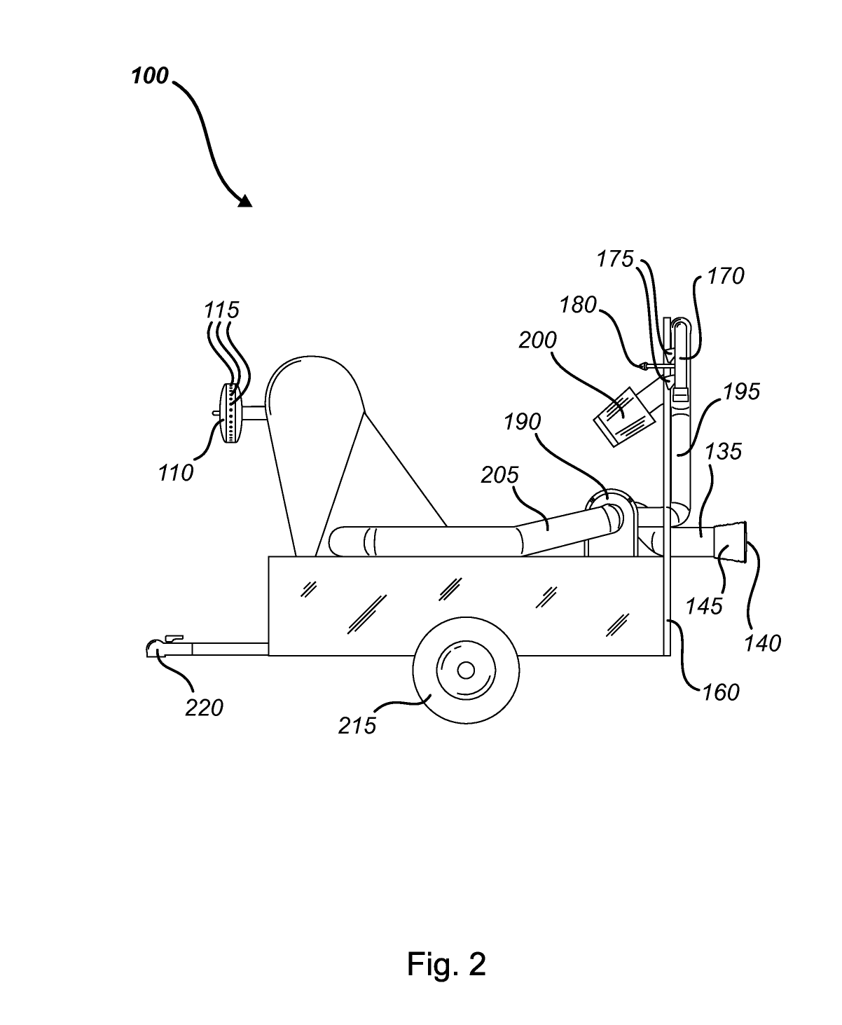

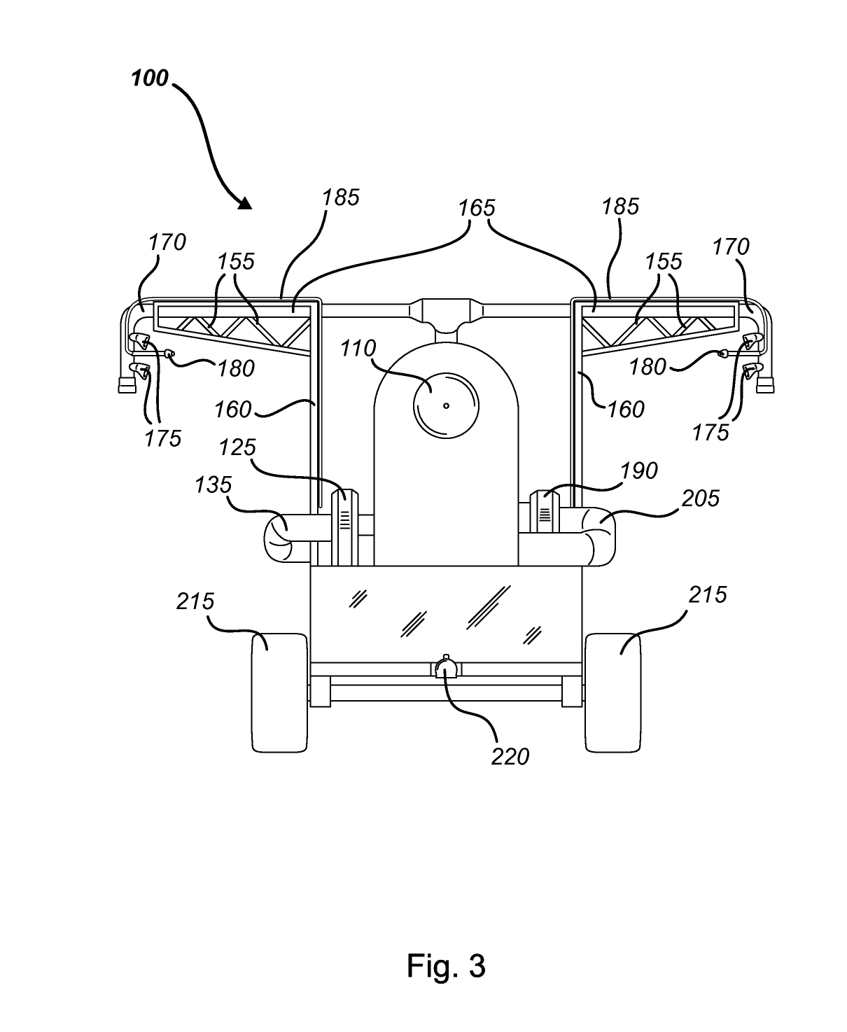

Turning to FIGS. 2 and 3, in one embodiment, vehicle 100 includes two wheels 215 on an axle. In various embodiments, vehicle 100 additionally includes one or two steerable or non-steerable front wheels. In one embodiment, vehicle 100 is motivated by towing via tow hitch 220. In one embodiment, vehicle 100 includes driven wheels and may thus be self-powered.

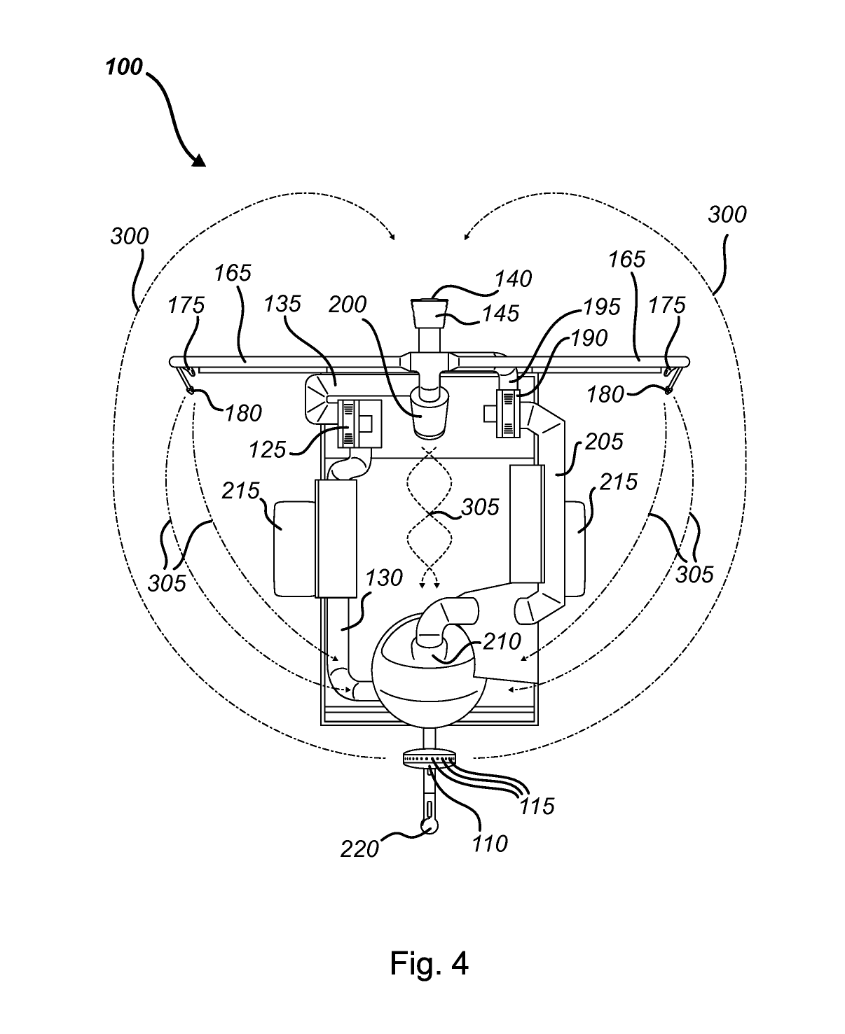

Referring now to FIG. 4, in one embodiment, primary blower 125 may be activated to create a first flow field envelope 300. In one embodiment, a first flow of air is ejected from air vents 115, surrounding a protected field. In one embodiment, the first flow field envelope 300 prevents ingress of bulk ambient air. For example, in one embodiment, as vehicle 100 moves forward or ambient winds blow around or at vehicle 100 the first flow field envelope 300 prevents ingress of bulk ambient air. In one embodiment, a substantially isolated field of circulating air may be maintained within the first flow field envelope 300, so as to minimize or reduce the potential for air that is circulating within the first flow field envelope 300 to drift out of the protected field. In one embodiment, the first flow of air of the first flow field envelope 300 passes around the protected field and is drawn into primary air intake vent 140, before the first flow of air passes through primary blower 125 and is recirculated through air vents 115.

In one embodiment, secondary blower 190 creates a second flow of air 305. In one embodiment, the second flow of air 305 includes air circulating in the protected field. In one embodiment, a chemical spray, an aerosol, particulate matter, and/or other substance may be entrained within the second flow of air 305. In various embodiments, the second flow of air 305 consists of turbulent and/or laminar flows. In one embodiment, second flow of air 305 is ejected from secondary side vents 175 and secondary central vent 200 and into the first flow field envelope 300. In one embodiment, air ejected from secondary central vent 200 may experience cyclonic mixing and circulation caused by vanes within secondary central vent 200. In one embodiment, air in the second flow of air 305 may be pulled into secondary intake vent 210, pass through secondary blower inlet duct 205 to secondary blower 190, and be recirculated through secondary side vents 175 and secondary central vent 200. In one embodiment, second flow of air 305 may include turbulent air flow within the first flow field envelope 300.

In one embodiment, spray nozzles 180 may emit a spray in liquid form, in aerosol form, as particulates entrained in a flow of air, and/or in other forms. In one embodiment, spray nozzles 180 may be adapted to emit an electrostatic spray. In one embodiment, a pump may be activated to transmit the spray from a storage tank to spray nozzles 180 through spray hose 185. In one embodiment, liquid stored in the tank is converted to aerosol by an atomizer installed at or near the tank or at spray nozzles 180. In one embodiment, an aerosol may selectively be applied as spray if doing so might result in increased coverage on target objects 310 in comparison to liquid spray.

In one embodiment, spray may enter the second flow of air 305 and remain entrained therein as the air recirculates through the system. Various embodiments may not include spray nozzles 180 located at the secondary side vents 175, but rather emit spray elsewhere into the second flow of air 305. In one embodiment, to apply a spray to a larger target object, volumetric air flows and air pressures may be increased to thereby increase the size of the field of recirculating air. In one embodiment, the size, direction, and number of air vents 115 may be altered to change the shape of the field of recirculating air.

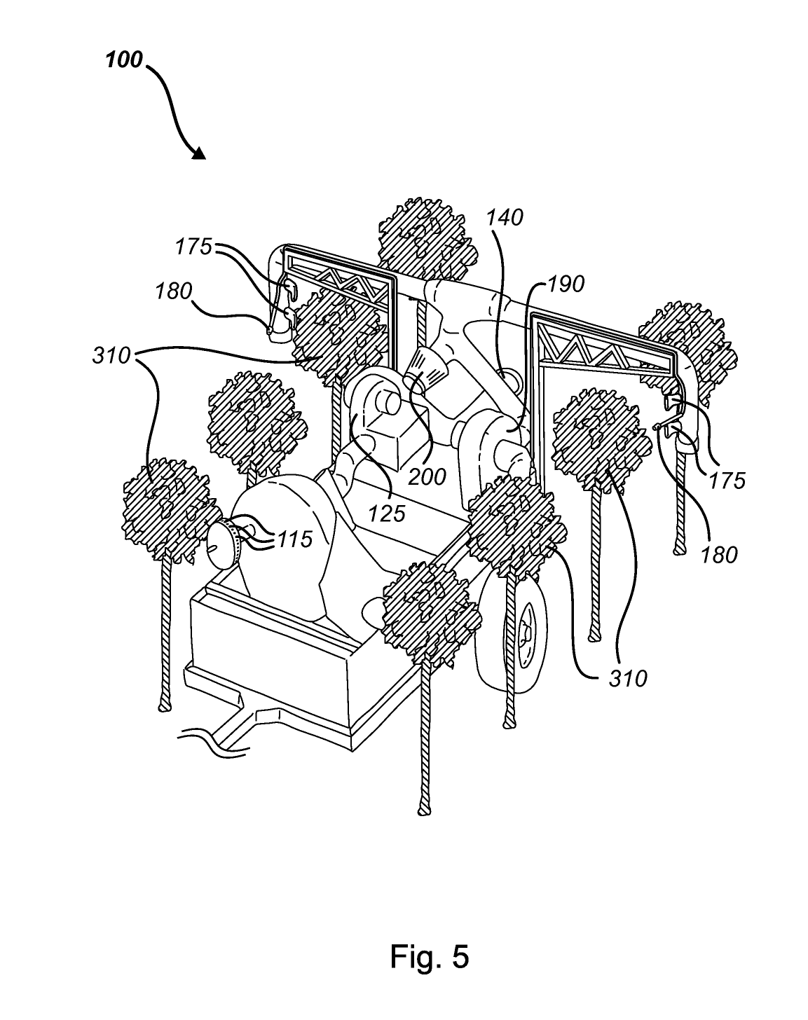

Referring now to FIG. 5, in one embodiment, vehicle 100 is moved next to target objects 310 or one or two rows of target objects 310 where a spray application is intended. In one embodiment, vehicle 100 may pass between rows of target objects 310 as primary blower 125 and secondary blower 190 create the first flow field envelope 300 and second flow of air 305 (depicted in FIG. 4) and to thereby encompass the target objects 310 within the field of second flow of air 305. In one embodiment, sprays may include pesticides, nutrients, fungicides, herbicides, defoliants, and the like, as desired. In one embodiment, due to the recirculation of the second flow of air 305 and the turbulent nature thereof, the spray entrained therein may contact target objects 310 at multiple angles and therefore may cover multiple surfaces, so that, for example, coverage may occur on all surfaces of foliage to be sprayed. In one embodiment, the speed of the vehicle 100, whether towed by a tractor, other tow vehicle, or under self-power, may be typical of existing spray methods, which may typically be four to five miles per hour. In one embodiment, the speed of the vehicle 100, whether towed by a tractor, other tow vehicle, or under self-power, may be faster than five miles an hour.

Various embodiments of the present disclosure may be utilized for spraying paint in automotive, aerospace, or like applications. Embodiments may be used for spraying deicing spray in aerospace or like applications, spraying paint on road surfaces, or other applications wherein a spray may be applied to a target object.

In various embodiments of the present embodiment, vehicle 100 includes curved skin surfaces at front and/or rear sections to improve laminar flow of first flow field envelope 300 and to keep the first flow field envelope 300 and second flow of air 305 from mixing with each other.

Systems and methods of the present disclosure may present numerous advantages over traditional spray technology and methods. Spray may be applied more precisely on target objects 310, so that fewer nozzles may be used. Spray may be ejected at lower pressure, using lower volumetric airflow, and with less chemicals emitted than traditional methods. The recaptured and recycled spray in the second flow of air 305 may result in less wasted chemicals, thereby resulting in less chemical released into the atmosphere and less overall cost.

Another advantage is that systems of the present disclosure may be employed in fields even with overhead obstacles such as power lines since there is no large spray recapture shell. Furthermore, embodiments of the present disclosure may be used in environments experiencing relatively strong side winds because the first flow field envelope 300 may isolate the protected field enclosed therein.

Turning now to FIG. 6, in one embodiment, a method of creating a protected field includes creating a first flow field envelope, as described in FIGS. 4 and 5, by directing a first flow of air 601 through primary blower 125. In one embodiment, primary blower 125 includes nose member 110. In one embodiment, the first flow of air 601 is a laminar flow. In one embodiment, at least a portion of the first flow of air 601 is drawn into a primary air intake vent 140. In one embodiment, by drawing in at least a portion of the first flow of air 601 into the primary intake vent 140, the first flow of air 601 passes around and envelopes a protected field. In one embodiment, at least a portion of the first flow of air 601 is drawn into primary air intake vent 140, before the first flow of air passes through primary blower 125 and is recirculated through nose member 110. In one embodiment, the first flow field envelope 300 provides an area protected from the atmosphere outside the first flow of air 601. While a particular shape is shown in FIG. 6, those of skill in the art will recognize that various shapes can be utilized to create a protected field. In one embodiment, the first flow of air 601 is directed against a skin, fin, and/or fairing to change direction of the first flow of air.

Turning to FIG. 6A, in one embodiment, a method of creating a protected field includes creating a first flow field envelope by directing a first flow of air 601 through primary blower 125 and drawing at least a portion of the first flow of air 601 into a primary air intake vent 140. In one embodiment, by drawing in at least a portion of the first flow of air 601 into the primary intake vent 140, the first flow of air 601 passes around and envelopes a protected field.

In one embodiment, second flow of air 305 is directed from a secondary central vent 200 and secondary side vents 175 into the protected field, inside the first flow of air 601. In one embodiment, a chemical spray, an aerosol, particulate matter, and/or other substance is entrained within the second flow of air 305. In one embodiment, the second flow of air 305 experiences cyclonic mixing and circulation from vanes (not depicted) within secondary central vent 200. In one embodiment, the second flow of air 305 is a turbulent flow within the protected field and around target objects 310. In one embodiment, the second flow of air 305 is drawn into secondary intake vent 210 and through secondary blower inlet duct 205 and recirculated through secondary side vents 175 and secondary central vent 200.

By entraining particulate matter within the second flow of air 305, the particulate matter is contained in the protected field, inside the first flow field envelope. Because the particulate matter is contained inside the first flow field envelope, the particulate matter is prevented from entering into the atmosphere. Thus, the method of creating a protected field is a method of minimizing particulate pollution. For example, when fertilizing a field, fertilizer particulates are entrained within the second flow of air and are thus contained inside the first flow field envelope. Because the fertilizer particulates are contained inside first flow field envelope, the particulates are not released into the atmosphere and therefore do not contribute to air pollution.

Furthermore, by entraining the fertilizer particulates within the second flow of air, the amount of fertilizer required for an effective treatment is drastically decreased. The inventor discovered that by entraining a chemical spray within the second flow of air 305, the amount of chemicals required to spray a one acre field decreased from 200 gallons to 11 gallons. Not only did the amount of chemicals required to spray a field decrease over 1800 percent, but the quality of the application increased as the coverage of chemicals on the plants greatly improved.

In one embodiment, the second flow of air 305 provides interior tension for the first flow field envelope. In one embodiment, the second flow of air 305 is directed in such a way that the second flow of air 305 maintains the desired shape of the first flow field envelope. For example, when creating a protected field in a field while spraying the field, changes in external wind speed and wind direction will affect the shape of first flow field envelope. If the wind is blowing from the south, the south facing aspects of the first flow of air will collapse. In one embodiment, the second central vent 200 directs the second flow of air 305 to counteract the effect of wind speed and wind direction. When, for example, the wind is blowing from the south, the second flow of air 305 is directed to the north, so that the second flow of air 305 counteracts the effect of the wind and maintains the shape of the first flow of air. Thus, the second flow of air 305 can be altered in direction and flow level to compensate for changes in wind speed and/or wind direction, and therefore maintain the shape of the first flow field envelope.

By counteracting the effects of wind speed and wind direction, the second flow of air 305 maintains the protected field inside the first flow field envelope. Thus, even as external winds change speed or direction, the atmosphere inside the first flow field envelope and the protected field remains relatively constant. Because of this relatively constant atmosphere, chemicals may be sprayed regardless of wind speed. Since spraying will no longer be limited by external wind speed, substantial time savings will result.

In one embodiment, dust is trapped inside the first flow of air 601, in the protected field and then entrained in a collection device. In one embodiment, an electrostatic charge is used to separate particulates from a primary air source. In one embodiment, the secondary air source 605 is directed towards one or more rods charged with electrostatic energy. In one embodiment, as particulates gather on the rods charged with electrostatic energy, the secondary air source 605 is momentarily diverted, allowing the particulates gathered on the rods to collect in a particulate receptacle. In one embodiment, the electrostatic energy charge associated with the rods is reversed, repelling the gathered particulates.

By separating particulates from a primarily air source, particle pollution associated with activities such as demolition, construction, and manufacturing can be contained, thereby preventing discharge of the particles into the environment. For example, toxic particles that may be released into the environment during the demolition of a building that contains asbestos can be separated from a primary air source and contained in a particulate receptacle.

As illustrative examples, in manufacturing and production settings, the sawdust associated with milling, the flour associated with baking, and the silica associated with ceramics can all be contained by separating the respective particles from a primary air source.

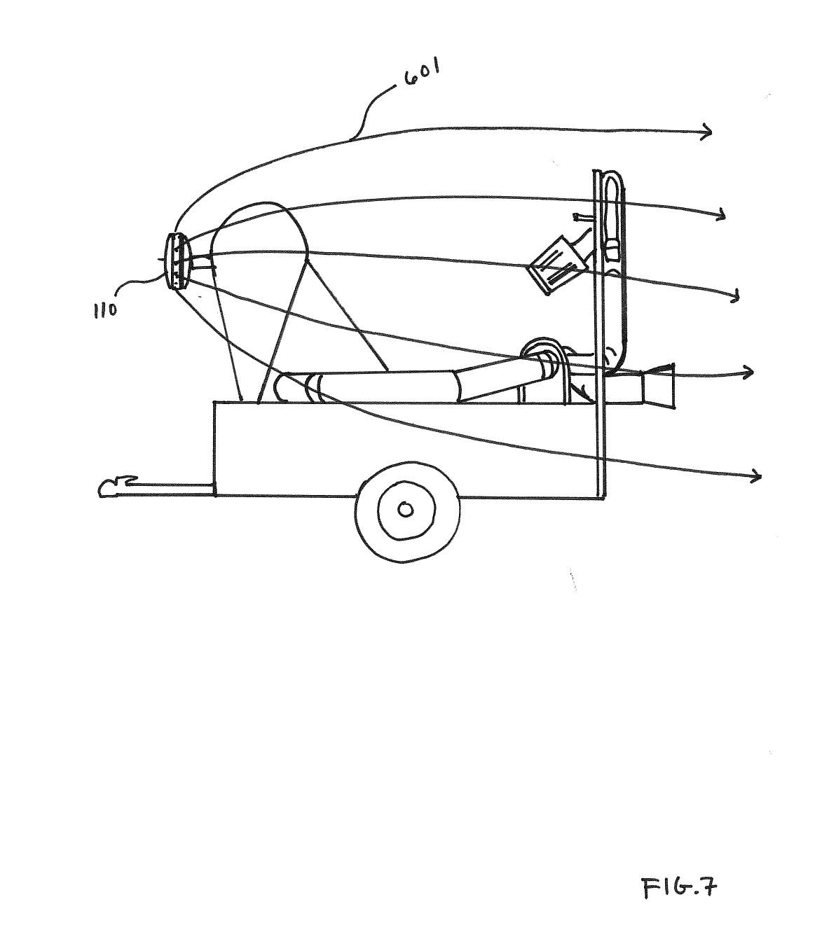

Turning to FIG. 7, in one embodiment, a method of creating a protected field includes directing an approximately laminar first flow of air 601 around a target space, creating a protected field within a first flow field envelope in an open configuration.

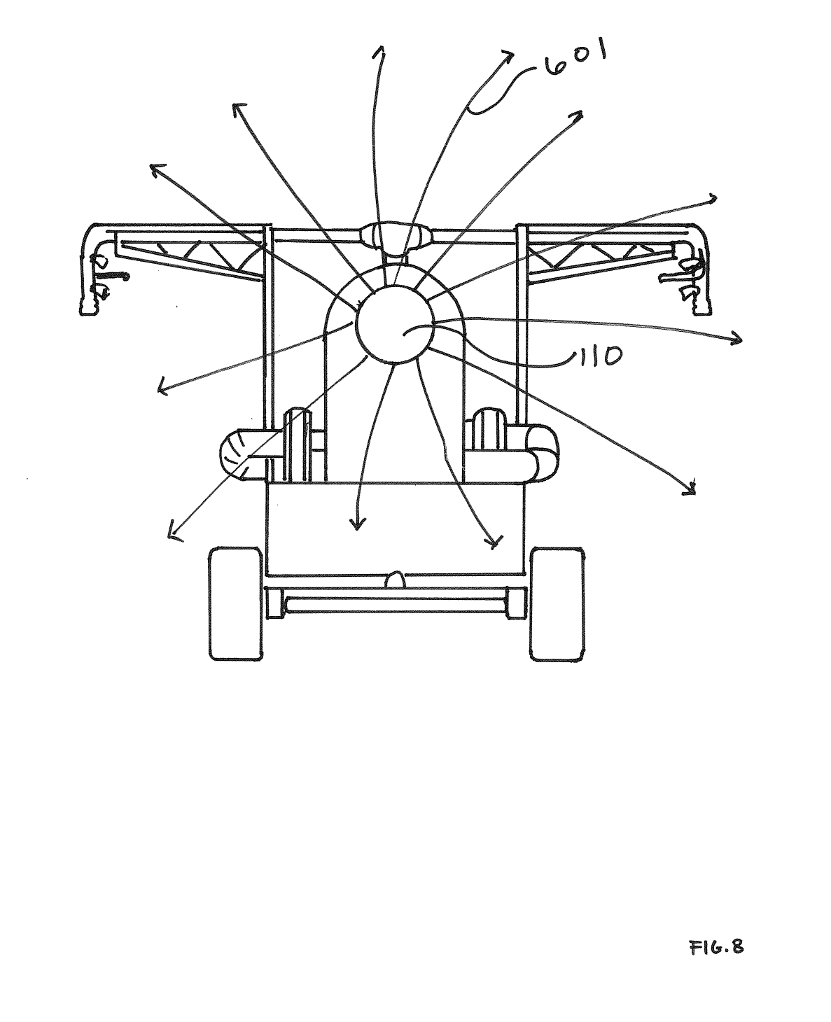

Moving to FIG. 8, in one embodiment, a method of creating a protected field includes directing an approximately laminar first flow of air 601 through a nose member 110 in a planar orientation. By creating a first flow of air 601 in a planar orientation, an air barrier is created to prevent the atmospheres on either side of the first flow of air 601 from mixing with one another.

As an illustrative example, in one embodiment, a method of creating a protected field is utilized in road construction. During construction, particulates associated with construction can interfere with vehicles using otherwise unaffected areas of the road. For example, in a four-lane highway, construction may be ongoing only in the first lane, but each of the other three lanes may be impacted by particulates from that construction. By creating a first flow of air directed in a planar orientation at the space between the first and second lanes, the second, third, and fourth lanes will be unaffected by any particulates emanating from the first lane. The first flow of air directed in a planar orientation traps the construction particulates in the first lane, preventing their migration into the other lanes.

It should be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In the discussion above, certain aspects of one embodiment include process steps and/or operations described herein for illustrative purposes in a particular order and/or grouping. However, the particular order and/or grouping shown and discussed herein are illustrative only and not limiting. Those of skill in the art will recognize that other orders and/or grouping of the process steps and/or operations are possible and, in some embodiments, one or more of the process steps and/or operations discussed above can be combined and/or deleted. In addition, portions of one or more of the process steps and/or operations can be re-grouped as portions of one or more other of the process steps and/or operations discussed herein. Consequently, the particular order and/or grouping of the process steps and/or operations discussed herein do not limit the scope of the invention as claimed below.

In addition, the operations shown in the FIG.s are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A method for creating a protected field comprising
directing a first flow of air;
creating a first flow field envelope by drawing in at least a portion of the first flow of air; and
directing a second flow of air inside the first flow field envelope.

2. The method of claim 1 wherein
the first flow of air is directed through a primary blower;
the at least a portion of the first flow of air is drawn in through a primary air intake vent; and
the second flow of air is directed through a secondary blower.

3. The method of claim 2 wherein the first flow field envelope extends from the primary blower to the primary air intake vent.

4. The method of claim 1, wherein directing the second flow of air includes directing the second flow of air to provide interior tension for the first flow field envelope.

5. The method of claim 2, further comprising mounting the primary blower and primary intake vent on a vehicle.

6. The method of claim 5, further comprising directing the first flow of air in a direction approximately parallel to a forward direction of the vehicle.

7. The method of claim 5, further comprising directing the first flow of air in a direction at an angle to a forward direction of the vehicle.

8. The method of claim 1, further comprising entraining a spray in the second flow of air.

9. The method of claim 8, wherein the entrained spray is one or more sprays selected from the group consisting of
a liquid;
an aerosol;
particulates entrained in a flow of air; and
an electrostatic spray.

10. The method of claim 1, further comprising recapturing particulates, wherein a particulate recapture system is located within a primary blower inlet duct.

11. The method of claim 10, further comprising separating particulates from a primary air source using an electrostatic charge.

12. A method for creating a field that may be shielded from ambient air, comprising:
creating a first flow field envelope by directing a first flow of air through a primary blower in a first direction, wherein the first flow of air is directed through a nose member including air vents, wherein the air vents include pass-through holes in the nose member; and
directing the first flow of air in a first direction through the air vents, wherein a primary blower directs the first flow of air in a first direction through the air vents.

13. The method of claim 12, further comprising directing a second flow of air inside the first flow field envelope.

14. The method of claim 12, further comprising mounting the primary blower and the nose member on a vehicle.

15. The method of claim 12, further comprising drawing in at least a portion of the first flow of air.

16. The method of claim 13, further comprising entraining a spray into the second flow of air.

17. The method of claim 16, wherein the entrained spray is one or more sprays selected from the group consisting of
a liquid;
an aerosol;
particulates entrained in a flow of air; and
an electrostatic spray.

18. The method of claim 17, further comprising drawing in the second flow of air.

19. A method for creating a field that may be shielded from ambient air, comprising:
directing a first flow of air through a primary blower, wherein the flow of air is directed in a planar orientation.

20. The method of claim 19, further comprising directing a second flow of air against the first flow of air to provide interior tension to maintain the planar orientation of the first flow of air.

21. The method of claim 20, further comprising entraining a spray into the second flow of air.

22. The method of claim 21, wherein the entrained spray is one or more sprays selected from the group consisting of
a liquid;
an aerosol; particulates entrained in a flow of air; and
an electrostatic spray.

23. The method of claim 19, wherein the first flow of air consists of a laminar flow.

24. The method of claim 20, wherein the second flow of air consists of cyclonic air movement.

25. The method of claim 20, wherein the first flow of air consists of laminar flow.
